(19) United States
(12) Patent Application Publication
(10) Pub. No.: US 2024/0211800 A1
(43) Pub. Date: Jun. 27, 2024

(54) PROCESSING EVENT DATA BASED ON MACHINE LEARNING

(71) Applicant: The Johns Hopkins University, Baltimore, MD (US)

(72) Inventors: Eileen Kasda, Baltimore, MD (US); Christine Robson, Baltimore, MD (US); Asa Adadey, Baltimore, MD (US); David Gillen, Baltimore, MD (US); Mario Koym-Garza, Baltimore, MD (US)

(21) Appl. No.: 18/088,074

(22) Filed: Dec. 23, 2022

(51) Int. Cl. G06N 20/00; G06F 18/23213

(52) U.S. Cl. CPC G06N 20/00; G06F 18/23213

(57) ABSTRACT

A computer-implemented method includes receiving, by a data processing system, event data representing a medical safety event. The method includes processing the event data, including: parsing, the event data to identify a structure of the event data; and identifying one or more fields from the structure of the event data. The method includes inputting, to a machine learning engine, contents of the one or more fields. The method includes generating, by the machine learning engine and from contents of the one or more fields, one or more feature vectors. The method includes accessing a plurality of indicator candidates. The method includes determining, by the machine learning engine and based on the one or more feature vectors, one or more indicators from the indicator candidates. The method includes tagging the event data with the one or more indicators. The method includes storing the tagged event data in a hardware storage device.

### BACKGROUND

Event reporting plays an important role in daily operations of many institutions. For example, in the healthcare industry, a healthcare institution may receive numerous reports from staff about medical safety events occurring on patients or facilities every day. To ensure quality of healthcare service and comply with regulations, healthcare institutions often need to respond to the event reporting within a very limited time period, and analyze the events on a regular basis.

### SUMMARY

In accordance with one aspect of the present disclosure, a computer-implemented method includes receiving, by a data processing system, event data representing a medical safety event. The method includes processing the event data, including: parsing, by a parser of the data processing system, the event data to identify a structure of the event data; and identifying one or more fields from the structure of the event data. The method includes inputting, to a machine learning engine, contents of the one or more fields. The method includes generating, by the machine learning engine and from contents of the one or more fields, one or more feature vectors. The method includes accessing, from a hardware storage device, a plurality of indicator candidates. The method includes determining, by the machine learning engine and based on the one or more feature vectors, one or more indicators from the indicator candidates. The method includes tagging, by the data processing system, the event data with the one or more indicators. The method includes storing the tagged event data in the hardware storage device.

In some implementations, the one or more feature vectors include one or more features and one or more corresponding scores.

In some implementations, the contents of the identified one or more fields include a plurality of words that describe the medical safety event. The one or more features are determined from the plurality of words. The one or more corresponding scores include one or more term frequency-inverse document frequency (TF-IDF) scores corresponding to the one or more features.

In some implementations, determining the one or more indicators from the plurality of indicator candidates includes: determining a probability value corresponding to each indicator candidate based on the one or more features and the one or more corresponding scores; comparing the probability value corresponding to each indicator candidate with a probability threshold value; and selecting the one or more indicators whose corresponding probability values are greater than the probability threshold value.

In some implementations, the method includes training the machine learning engine with a set of sample event data, wherein the sample event data are tagged with one or more sample indicators.

In some implementations, training the machine learning engine with the set of sample event data includes: obtaining one or more sample feature vectors from the sample event data; obtaining an indicator vector from the sample event data, wherein the indicator vector includes a plurality of fields indicating a presence or absence of the plurality of indicator candidates; and inputting the one or more sample feature vectors and the one or more indicator vectors to a logistic regression classifier to obtain a prediction model.

In some implementations, training the machine learning engine with the set of sample event data further includes: obtaining one or more prediction metrics from a set of test event data; and determining a probability threshold value for the prediction model.

In some implementations, the one or more prediction metrics include: a precision threshold value and a recall threshold value.

In some implementations, determining the one or more indicators from the plurality of indicator candidates includes: determining a parent indicator from the plurality of indicator candidates; and determining a child indicator from the plurality of indicator candidates based on the parent indicator. The one or more indicators are determined as at least one of the parent indicator or the child indicator.

In some implementations, the method includes receiving a query that includes a given event indicator; searching the tagged event data in the hardware storage device; and displaying a search result of event data that are tagged with the given event indicator.

In some implementations, the method includes creating, by the machine learning engine, a new indicator candidate; and storing the new indicator candidate by the hardware storage device.

In some implementations, the method includes performing k-means clustering analysis according to the one or more features.

In one aspect, a non-transitory computer-readable medium stores program instructions that cause a data processing system to perform operations. In some implementations, these operations are similar to one or more of those of the computer-implemented method described above.

### BRIEF DESCRIPTION OF THE DRAWINGS

FIG. 1 illustrates a block diagram of an example system for processing event data, according to some implementations.

FIG. 2 illustrates an example flow for determining an indicator for event data using a machine learning engine, according to some implementations.

FIG. 3 illustrates an example flow for determining indicators at two levels and tagging event data with determined indicators, according to some implementations.

FIG. 4 illustrates an example flow for training a machine learning engine, according to some implementations.

FIG. 5 illustrates an example flow for determining a probability threshold value of an indicator candidate, according to some implementations.

FIG. 6 illustrates example analysis results obtained from k-means clustering, according to some implementations.

FIG. 7 illustrates a flowchart of an example method for processing event data, according to some implementations.

FIG. 8 is a block diagram of an example computer system 800 in accordance with one or more implementations of the present disclosure.

Figures are not drawn to scale. Like reference numbers refer to like components.

### DETAILED DESCRIPTION

Medical safety event reports often come in as narrative free text that is not restricted to a particular format. With a large amount of events reported every day, significant human involvement may be needed to comprehend the nature of the events accurately and make responsive decisions timely. This can potentially increase the cost of healthcare institutions, increase the delay for responses, and make routine analysis difficult to conduct.

In light of the challenges above, this disclosure utilizes machine learning to facilitate the processing of reported event data. For example, implementations of the disclosure use a machine learning engine to tag reported event data with one or more indicators. This can allow the event data to be automatically routed to corresponding personnel for quick response. The machine learning techniques described herein provide for the faster processing of data relative to the speed at which this data is processed without machine-learning, such as using data matching techniques that label data. This is because the machine-learning techniques are heuristic and include a feedback loop for automatically updating a machine-learning model to more accurately tag and detect event data of specific types. This more accurate detection and tagging results in few inaccurate tags, which introduce latency into the system by requiring human intervention to properly tag event data. Tagging event data with indicators can also simplify the process of enquiring into and analyzing a large amount of data. Thanks to one or more of these features, implementations of the disclosure provide a fast, automated, and cost-saving approach of managing and processing medical safety event reports.

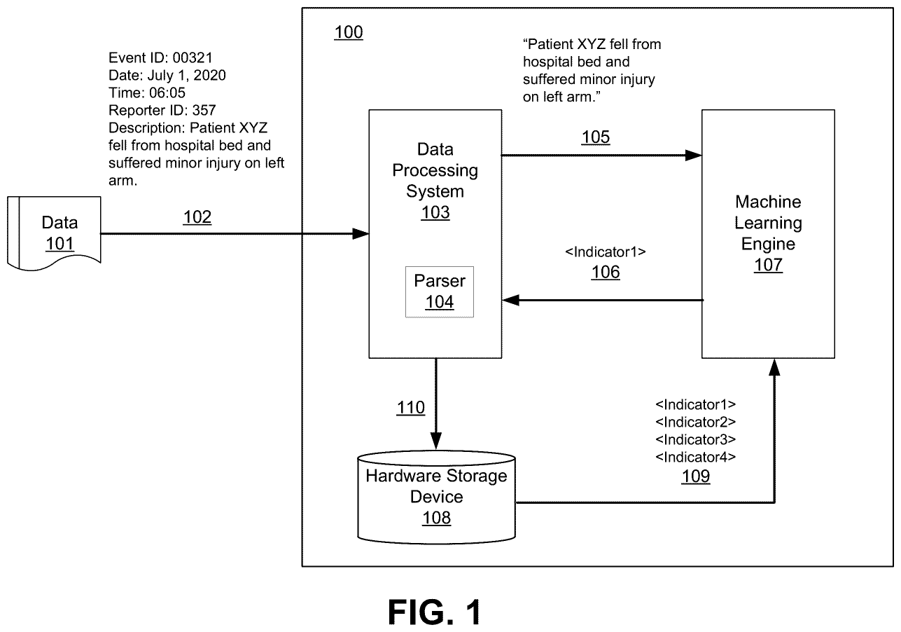

FIG. 1 illustrates a block diagram of an example system 100 for processing event data, according to some implementations. System 100 can be implemented on one or more computers, mobile devices, or network devices. System 100 primarily includes 3 components: data processing system 103, machine learning engine 107, and hardware storage device 108.

In some implementations, data processing system 103 includes computer hardware and software for receiving, accessing, processing, and outputting data, such as data 101 that describe one or more events. For example, data processing system 103 can include one or more interfaces for exchanging data with external devices, and can include one or more processors for executing various tasks. In particular, the one or more processors can be configured as a parser 104 to extract contents from received data.

In some implementations, machine learning engine 107 includes software code of one or more machine learning algorithms. The machine learning algorithms can include training steps, in which the machine learning engine 107 is trained with sample data sets, and prediction steps, in which the machine learning engine 107 makes predictions for actual data based on features thereof. The software code of machine learning engine 107 can be executed on a computer that is either part of data processing system 103 or independent to data processing system 103.

In some implementations, hardware storage device 108 includes storage circuitry, such as a memory. Hardware storage device 108 can be configured to store data of various formats and from various sources. For example, hardware storage device 108 can store program instructions for executing various tasks of data processing system 103, the machine learning algorithms of machine learning engine 107, and indicator candidates 109 used for processing the received data 101. Hardware storage device 108 can be implemented either as part of data processing system 103 or independent to data processing system 103.

Data 101 describe one or more events, such as safety-related events happening on a healthcare facility. Each entry of data 101 can be structured to have one or more fields 102 that describe an event from various aspects. For example, fields 102 can include Event ID, Date, Time, Reporter ID, and Description. In particular, the Description of an event can be narrative free text, with which a reporter uses narrative language to describe that which happened at the event. Data 101 can have more or fewer fields than those in fields 102. For example, some implementations may not have separate Date and Time fields, so a reporter needs to include such information in the text of the Description field. Fields 102 of data 101 can have different names. For example, instead of using the term “Description,” some implementations can use “Note,” “Comment,” or “Event Detail” to indicate similar descriptive information of the event.

System 100 receives and processes data 101. For example, data processing system 103 includes a parser for parsing data 101 and—based on the structure of data 101—identifying fields in data 101 and associated values or content of these fields. For example, the parser can be configured to detect or identify the following data structure: data, data, data. In this example, the “,” is the structure that is delineating fields. The parser parses data 101 and identifies the portion of data preceding each “,” as being included in a field and the portion of data being the value of that field. Example operations of the processing are described below based on example fields 102 shown in FIG. 1.

In some implementations, data processing system 103 receives data 101. The reception of data 101 can be via a wired system interface or via a wireless transmission.

Data processing system 103 then parses data 101 using parser 104 to identify the structure of data 101. For example, parser 104 can identify some or all of the fields Event ID, Date, Time, Reporter ID, and Description by text matching. Parser 104 can also extract the contents of the identified fields.

After parsing data 101, data processing system 103 obtains event description from the content of the Description field. In the example of FIG. 1, data processing system 103 obtains the event description as “Patient XYZ fell from hospital bed and suffered minor injury on left arm.”

Data processing system 103 then inputs the obtained content 105 of the Description field to machine learning engine 107. The transmission of content 105 can be via a software signal only, or can be via a hardware component such as a cable.

Machine learning engine 107 executes one or more machine learning algorithms to process input content 105. Specifically, machine learning engine 107 accesses hardware storage device 108 to look for a plurality of indicator candidates 109. Indicator candidates 109 can each be, e.g., a short phrase with one or a few words, numbers, symbols, or a combination of the three, such as <Indicator1>, <Indicator2>, <Indicator3>, and <Indicator4>. From indicator candidates 109, machine learning engine 107 can identify one or more indicators 106, such as <Indicator1>, that is/are most relevant to content 105. In other words, machine learning engine 107 classifies content 105 into one or more categories denoted by the identified one or more indicators 106.

Data processing system 103 obtains one or more indicators 106 identified by machine learning engine 107. Data processing system 103 then tags data 101 with one or more indicators 106. To tag data 101, data processing system 103 creates a logical association between data 101 and one or more indicators 106. In some implementations, data processing system 103 introduces a new field, such as “Tag” or “Label,” whose content is one or more indicators 106.

Data processing system 103 then stores tagged data 101 in hardware storage device 108. For example, data processing system 103 can designate a memory space for each of values of fields 102 of data 101, plus the additional field “Tag” or “Label.” That is, data processing system 103 stores in hardware storage device 108 a value (of a field) and the tag or label. Additionally, hardware storage device 108 can store a pointer or other data structure that relates or associates the value of the field with the tag or label.

With the above features and operations, system 100 provides an automated mechanism to classify a large amount of event data entries into a small number of categories based on the nature of the events described. Tagged event data 108 can then be routed to appropriate staff for quick response according to the classification. The classification does not require much human involvement and thus reduces likelihood of human error or confusion. One can also query hardware storage device 108 to look for events tagged with a given indicator and have the search results displayed. In addition, by tagging event data, system 100 allows for efficient management of historic events using statistical methods, such as k-means clustering.

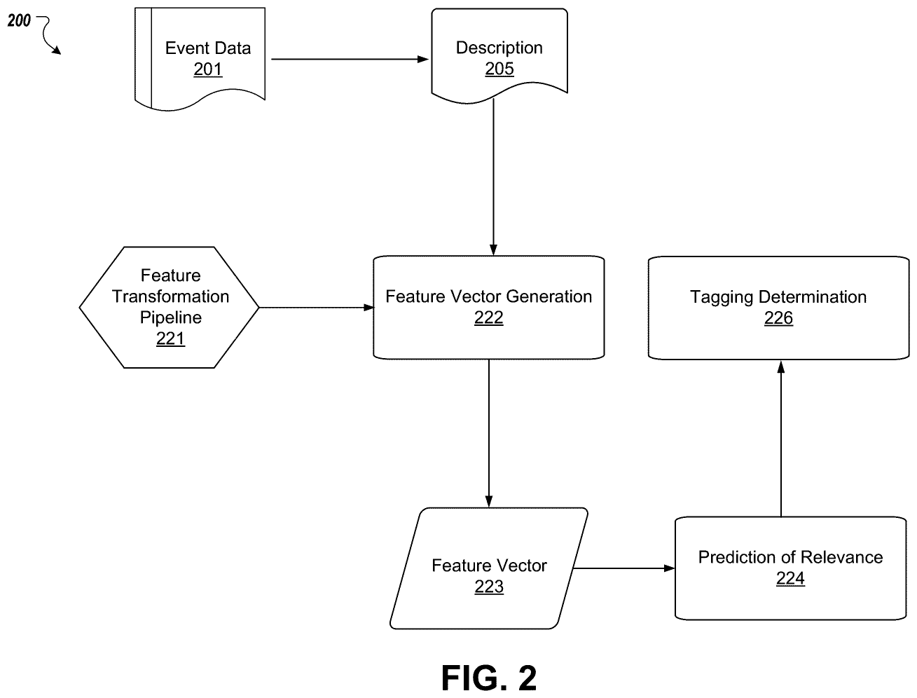

FIG. 2 illustrates an example flow 200 for determining an indicator for event data 201 using a machine learning engine, according to some implementations. In some implementations, one or more operations in flow 200 can be implemented by machine learning engine 107 in system 100 of FIG. 1, and event data 201 in flow 200 can be similar to data 101 of FIG. 1.

At operation 222, the machine learning engine generates one or more feature vectors 223 based on description 205 of event data 201. In some implementations, each feature vector 223 is constructed to include one or more features identified from description 205 and a score corresponding to each identified feature. The machine learning engine can be trained to, e.g., identify features from description 205, combine similar features, and calculate scores of the features. The generation of one or more feature vectors 223 can further take inputs from feature transformation pipeline 221, which provides the machine learning engine with parameters relating to, e.g., formatting or weighting used in the generation of feature vectors 223.

As an example of feature vector generation, the machine learning engine identifies each word in description 205 as a feature and calculates a term frequency-inverse document frequency (TF-IDF) score for each feature. The TF-IDF score measures the feature's relevance to event data 201 in a collection of event data (e.g., historic event data stored in storage device 108). A feature's TF-IDF score is high if the feature is common in event data 201 and decreases if the feature is also common in the collection of event data. By using TF-IDF scoring to generate feature vectors 223, the machine learning engine can evaluate the importance of features (e.g., words) in event data 201. Other types of scores can be used in addition to or in lieu of TF-IDF scores in some implementations.

At operation 224, the machine learning engine makes a prediction of relevance of event data 201 to each indicator candidate. For example, the machine learning engine can utilize a prediction model to calculate, based on the feature vector generated from event data 201, a probability value for each indicator candidate. A high probability value can suggest high relevance of event data 201 to an indicator candidate, and a low probability value can suggest low relevance of event data 201 to the indicator candidate. The machine learning engine can generate or modify the prediction model from training.

At operation 226, the machine learning engine determines whether to tag event data 201 with each indicator candidate. In some implementations, the determination is by comparing the probability value of a specific indicator candidate with a probability threshold value. If the probability value of the indicator candidate exceeds or equals the probability threshold value, it means event data 201 is sufficiently relevant to the indicator candidate to support an association between event data 201 and the indicator candidate. The machine learning engine can thus inform a data processing system, such as data processing system 103 of FIG. 1, that event data 201 can be tagged with the indicator candidate. Conversely, if the probability value of the indicator candidate is below the probability threshold value, it means event data 201 is not sufficiently relevant to the indicator candidate to support an association between event data 201 and the indicator candidate. The machine learning engine and the data processing system thus do not proceed with tagging event data 201 with the indicator candidate. The probability threshold value can be obtained from training, or can be manually configured by human. The probability threshold value can be the same for all indicator candidates, or can be different for different indicator candidates.

As mentioned above, the indicator candidates are typically short phrases having a small number of words. As such, in some scenarios, a single-level classification may not be enough to effectively cover the diversity of events. Using description 105 as an example, while “Patient XYZ fell from hospital bed and suffered minor injury on left arm” may be tagged with an indicator “Injury,” a distinct event described as “Patient ABC was admitted to ICU for severe injury from car accident” may also be tagged with “Injury.” The second event may need attention primarily from medical treatment staff, while the first event may need more attention from facility management staff for potential negligence liability. Thus, implementations of this disclosure contemplate multi-level classification with a top-level classification and one or more levels of sub-classifications. For example, under “Injury,” there can be sub-level indicator candidates such as “Pre-existing,” “On-site,” and “Unknown.” The indicator candidates of different levels can be stored separately at, e.g., hardware storage device 108. The operations for determining the top-level and sub-level indicators can be substantially the same, although the probability threshold values may or may not be the same for top-level and sub-level determinations.

Although the machine learning engine may associate event data 201 with one or more top-level indicators and one or more sub-level indicators, the data processing system may or may not tag event data 201 with indicators of all levels. For example, if the machine learning engine associates event data 201 with a top-level indicator “Injury” and a sub-level indicator “On-site,” then the data processing system can tag event data 201 with indicators of both levels, such as “Injury: On-site.” By contrast, some implementations may phrase sub-level indicators to include top-level indicators, such as “Pre-existing Injury,” “On-site Injury,” and “Unknown Injury” under the top-level indicator “Injury.” In this case it is not necessary to tag event data 201 with indicators of both levels. Instead, the data processing system can tag event data 201 with sub-level indicators only. Whether to tag event data with indicators of both/all levels or just one level can be implementation-dependent.

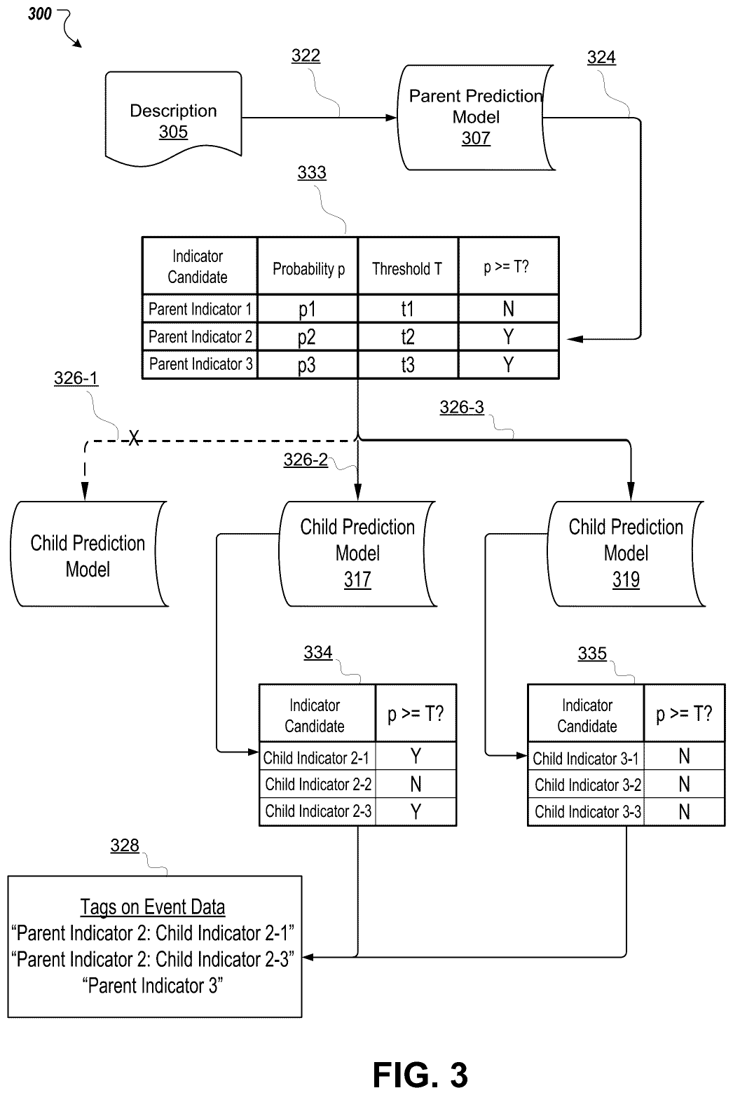

FIG. 3 illustrates an example flow 300 for determining indicators at two levels and tagging event data with determined indicators, according to some implementations. The top-level indicators are referred to as parent indicators, and the sub-level indicators are referred to as child indicators. In flow 300, the event data, the machine learning engine that makes the determination, and the data processing system that performs the tagging, can be similar to data 101, machine learning engine 107, and data processing system 103, respectively, of FIG. 1. Flow 300 assumes that the data processing system is configured with two-level tagging: If indicators at both levels are identified, then the event data are tagged with indicators at both levels; if a parent indicator is identified but no child indicator under the parent is identified, then the event data are tagged with the parent indicator only.

At operation 322, description 305 is extracted from event data and input to parent prediction model 307 of a machine learning engine. As described above, parent prediction model 307 can be obtained from the training of the machine learning engine to determine the probability value for each parent indicator candidate.

At operation 324, parent prediction model 307 calculates the probability value for each of three parent indicator candidates: parent indicator 1, parent indicator 2, and parent indicator 3. The probability values for the parent indicator candidates, denoted as p1, p2, and p3, are compared with the corresponding probability threshold values, denoted as t1, t2, and t3. As also described above, t1, t2, and t3, which may or may not be the same, can be obtained from the training of the machine learning engine. Flow 300 assumes p1<t1, p2>t2, and p3>t3. The comparison results are shown in table 333.

Based on the results, the machine learning engine stops processing parent indicator 1 at operation 326-1, but continues to process parent indicators 2 and 3 at operations 326-2 and 326-3, respectively.

Specifically, at operation 326-2, description 305 is input to child prediction model 317 of the machine learning engine to calculate the probability value for each of three child indicator candidates under parent indicator 2: child indicator 2-1, child indicator 2-2, and child indicator 2-3. The calculated probability values, denoted as p21, p22, and p23, are compared with the corresponding probability threshold values, denoted as t21, t22, and t23. t21, t22, and t23, which may or may not be the same, can be obtained from the training of the machine learning engine. Assuming p21>t21, p22<t22, and p23>t23, the comparison results are shown in table 334.

Similarly, at operation 326-3, description 305 is input to child prediction model 319 of the machine learning engine to calculate the probability value for each of three child indicator candidates under parent indicator 3: child indicator 3-1, child indicator 3-2, and child indicator 3-3. The calculated probability values, denoted as p31, p32, and p33, are compared with the corresponding probability threshold values, denoted as t31, t32, and t33. t31, t32, and t33, which may or may not be the same, can be obtained from the training of the machine learning engine. Assuming p31<t31, p32<t32, and p33<t33, the comparison results are shown in table 335.

At operation 328, the data processing system performs tagging based on the results from operations 326-2 and 326-3. Because child indicators 2-1 and 2-3 are identified under parent indicator 2, the data processing system tags the event data with “parent indicator 2: child indicator 2-1” and “parent indicator 2: child indicator 2-3.” Because no child indicator is identified under parent indicator 3, the data processing system tags the event data with “parent indicator 3.”

In flow 300 described above, parent prediction model 307, child prediction model 317, and child prediction model 319 may be obtained from separate training processes or may be obtained from the same training process of the machine learning engine. The three prediction models 307, 317, and 319 may be implemented as the same block of software or may be implemented as separate blocks of software.

The machine learning engine can be trained with a sample data set for making predictions. The sample data set can include event data that are already appropriately tagged (e.g., by human) with sample indicators. Through training, the machine learning engine can develop the capability of predicting the relevance between event description and indicators. In particular, the predicted relevance can be mathematically presented as one or more probability values.

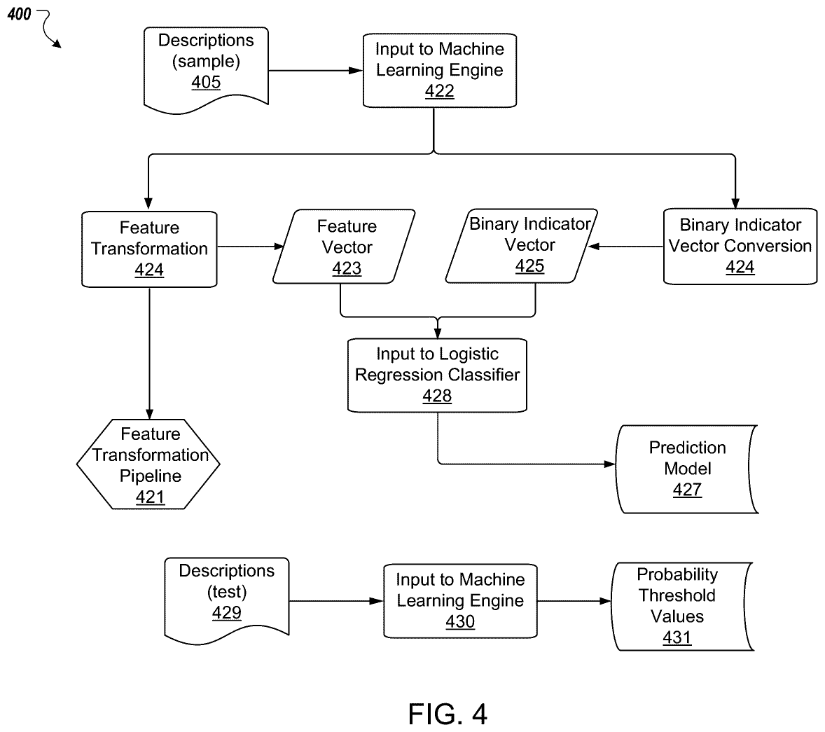

FIG. 4 illustrates an example flow 400 for training a machine learning engine, according to some implementations. The trained machine learning engine can be similar to machine learning engine 107 of FIG. 1, and the sample indicators used for training can include at least part of indicator candidates 109 of FIG. 1.

At operation 422, descriptions 405 of a sample set of tagged event data are input to the machine learning engine. The corresponding indicators are also input to the machine learning engine along with descriptions 405.

At operation 424, descriptions 405 undergo feature transformation to generate one or more features vectors 423. For example, the feature transformation at 424 can be a TF-IDF transform that identifies each word of a description as a feature, calculates a score corresponding to each identified feature, and constructs a feature vector to include the identified features and the corresponding scores. The feature transformation at 424 can also generate a feature transformation pipeline 421, such as feature transformation pipeline 221, with parameters relating to, e.g., formatting or weighting of the transformation. The feature transformation pipeline thus can be used by the machine learning engine to ensure consistency of parameters in feature vector generation during, e.g., operation 222.

At operation 426, the indicators tagged to each description 422 are converted to a binary indicator vector 425. For example, each element of the binary indicator vector 425 can correspond to one indicator candidate at a given level. The value of each element can be binary (e.g., 1 or 0) to indicate whether or not the description is tagged with the one indicator candidate or any corresponding sub-level indicators candidates.

At operation 428, feature vectors 423 and binary indicator vectors 425 of all descriptions 405 are input to a logistic regression classifier. The logistic regression classifier outputs a prediction model 427. Prediction model 427 is capable of receiving descriptions of event data and making predictions of the relevance of the descriptions to each indicator candidate. The relevance can be represented as a probability value.

At operation 430, descriptions 429 of a test data set are input to the machine learning engine to evaluate precision and recall metrics for each indicator candidate. The precision and recall metrics are then used to calculate probability threshold value 431 corresponding to each indicator candidate. The calculation can be based on, e.g., F-score analysis, which is commonly used in statistical analysis. Example software implementations of F-score analysis can be found at scikit-learn.orgstable/modules/generated/sklearn.metrics.fbeta_score.html, which is incorporated herein by reference. Similar to the sample set of tagged event data, the test data set can include event data that are already appropriately tagged (e.g., by human) with indicators.

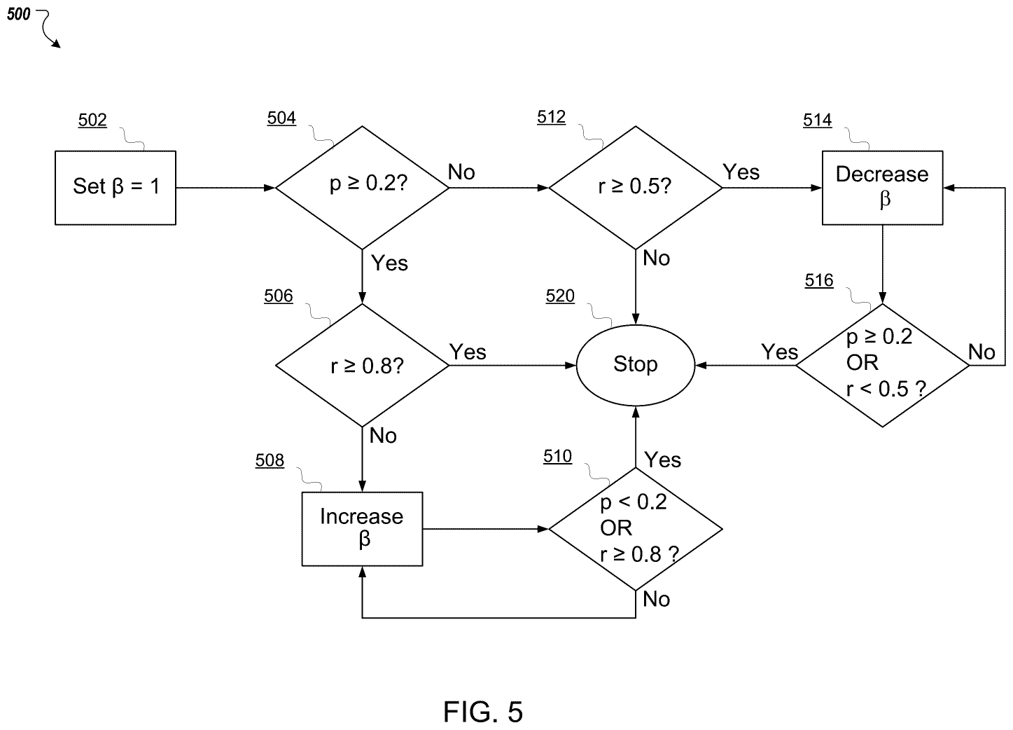

In general, an arbitrarily-set probability threshold value corresponds to a precision value and a recall value. Changing the probability threshold value leads to changes of the precision value and the recall value. Thus, the training algorithm can set target ranges for the precision value and the recall value in an F-score analysis, iteratively calculates an F-beta value (which correspond to the probability threshold value), and adjust the calculation until the precision and the recall values are within the target ranges. The setting of target ranges can include, e.g., setting a hard limit of recall, a hard limit of precision, and a soft limit of recall. The target ranges determine the likelihoods of false positives (i.e., incorrectly identifying an indicator that should not have been identified as relevant) and false negatives (i.e., incorrectly missing an indicator that should have been identified as relevant). Different implementations can set different target ranges to reflect different choices of trade-off between the two types of false prediction. Details of the calculation of the probability threshold value are described below with reference to FIG. 5.

FIG. 5 illustrates an example flow 500 for determining a probability threshold value of an indicator candidate using F-score analysis, according to some implementations. In flow 500, β denotes an input for calculating the F-beta value corresponding to the probability threshold value, p denotes a precision metric obtained from the test data set, and r denotes a recall metric obtained from the test data set. The values of p and r change along with β. In this example, the hard limit of recall is set to be 0.5, the hard limit of precision is set to be 0.2, the soft limit of recall is set to be 0.8, and the initial value of β is 1. These values are for example only. Other implementations can set these values differently. Flow 500 can be executed multiple times for indicators at different levels.

At operation 502, B is initialized to 1. The corresponding values of p and r can be obtained from the test data set.

At operation 504, it is determined whether p≥0.2 when β is at the initial value.

If p≥0.2 at operation 504, then flow 500 proceeds to operation 506 to determine whether r≥0.8 when β is at the initial value. If r≥0.8 at operation 506, then flow 500 stops at operation 520 and the current value of β is determined for calculating the probability threshold value (F-beta).

If r<0.8 at operation 506, then flow 500 proceeds to operation 508 to increase β. Each time β is increased at operation 508, flow 500 proceeds to operation 510 to determine whether p<0.2 or r≥0.8. Until p<0.2 or r≥0.8 is satisfied at operation 510, flow 500 repeats operation 510 to increase β. Once p<0.2 or r≥0.8 is satisfied at operation 510, flow 500 stops at operation 520 and the current value of β is determined for calculating the probability threshold value (F-beta).

Back to operation 504, if p<0.2 at operation 504, then flow 500 proceeds to operation 512 to determine whether r≥0.5 when β is at the initial value. If r<0.5, then flow 500 stops at operation 520 and the current value of β is determined for calculating the probability threshold value (F-beta).

If r≥0.5 at operation 512, then flow 500 proceeds to operation 514 to decrease β. Each time β is decreased at operation 514, flow 500 proceeds to operation 516 to determine whether p≥0.2 or r<0.5. Until p≥0.2 or r<0.5 is satisfied at operation 516, flow 500 repeats operation 514 to decrease β. Once p≥0.2 or r<0.5 is satisfied at operation 516, flow 500 stops at operation 520 and the current value of β is determined for calculating the probability threshold value (F-beta).

In flow 500, the amount of increase or decrease of β at operation 510 and 514 can be pre-defined as a small amount, such as 0.01, depending on the computing resources available. In addition, in an effort to expedite the iterations, some implementations may set the initial value of β to be another value, such as 0.25, 0.333, 0.5, 0.667, 1.5, 2, 3, or 4.

With the prediction models obtained (e.g., from flow 400) and the probability threshold values obtained (e.g., from flow 500), the machine learning engine is trained to process event data to determine the indicators for tagging. The process is highly automated and requires very limited human involvement.

In addition, the machine learning engine can be configured to identify features (e.g., words or phrases in event data descriptions) that frequently appear but have low relevance to any existing indicators. The machine learning engine can thus create one or more new indicator candidates and add the new indicator candidates to existing indicator candidates for tagging. This can reduce the likelihood that certain types of events are not identified and given enough attention.

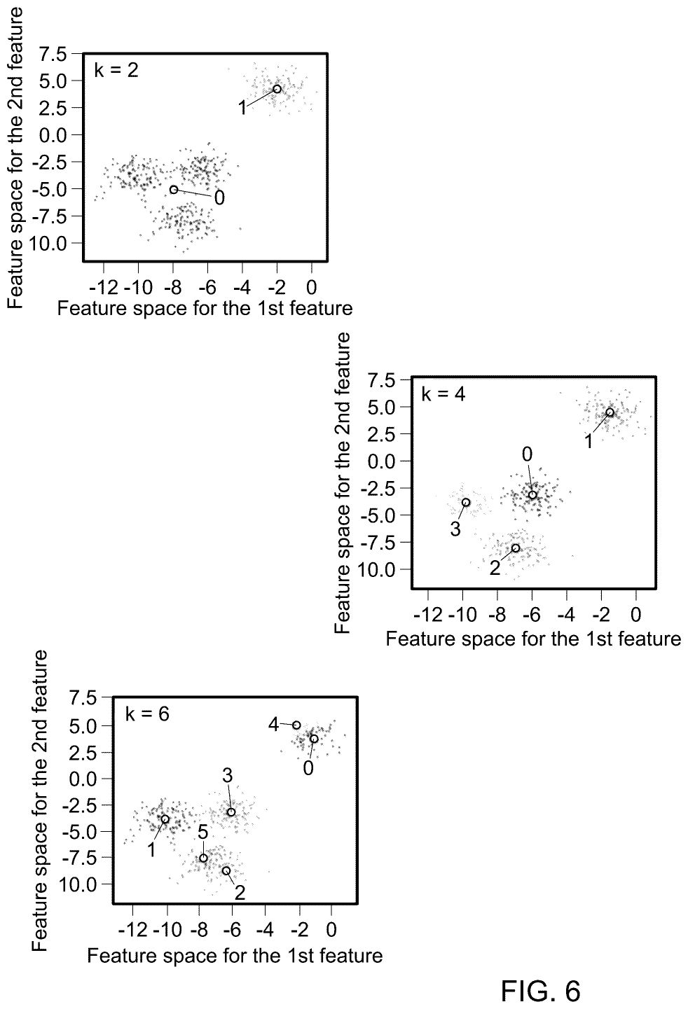

FIG. 6 illustrates example results obtained from k-means clustering analysis on tagged event data, according to some implementations. The analysis can be performed, e.g., by data processing system 103 on tagged event data 110. The extraction of features can be similar to operation 222.

FIG. 6 shows results for k=2, k=4, and k=6, in which the tagged event data are shown as forming 2, 4, and 6 clusters, respectively, numbered from 0 to k-1 in each graph. As can be seen in FIG. 6, k-means clustering analysis on features extracted from the tagged event data can help a user visually learn the concentration of features in a feature space. In the healthcare industry, this analysis can help healthcare institutions identify the common types of events reported and take measures accordingly. In some implementations, the results can be cached in a storage device, such as hardware storage device 108, for a period of time (e.g., one day). The data processing system can be configured to not update the cached results with new event data received within the same period unless the new event data amount to a significant increase (e.g., 20% or more) from the existing event data. This configuration can improve consistency of results that are seen by users multiple times within the same period.

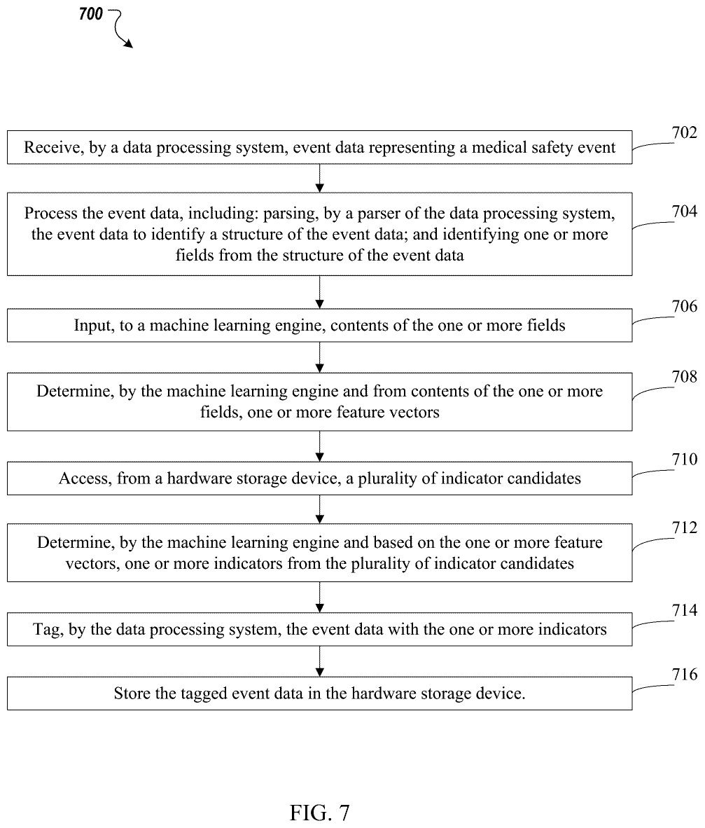

FIG. 7 illustrates a flowchart of an example method 700 for processing event data, according to some implementations. For clarity of presentation, the description that follows generally describes method 700 in the context of the other figures in this description. It will be understood that method 700 can be performed, for example, by any suitable system, environment, software, hardware, or a combination of systems, environments, software, and hardware, as appropriate, such as system 100 of FIG. 1. One or more steps of method 700 can be substantially the same as or similar to the operations described with reference to FIGS. 1-3. In some implementations, various steps of method 700 can be run in parallel, in combination, in loops, or in any order.

At 702, method 700 involves receiving, by a data processing system, event data representing a medical safety event. The data processing system can be similar to data processing system 103 of FIG. 1, and the event data can be similar to data 101 of FIG. 1 or event data 201 of FIG. 2.

At 704, method 700 involves processing the event data. The processing includes parsing, by a parser of the data processing system, the event data to identify a structure of the event data, and identifying one or more fields from the structure of the event data. The parser can be similar to parser 104 of FIG. 1, and the one or more fields can be similar to some or all of fields 102 of FIG. 1.

At 706, method 700 involves inputting, to a machine learning engine, contents of the one or more fields. The machine learning engine can be similar to machine learning engine 107 of FIG. 1, and the contents can be similar to content 105 of FIG. 1.

At 708, method 700 involves generating, by the machine learning engine and from contents of the one or more fields, one or more feature vectors. The generation of one or more feature vectors can be similar to operation 222 described with reference to FIG. 2.

At 710, method 700 involves accessing, from a hardware storage device, a plurality of indicator candidates. The hardware storage device can be similar to hardware storage device 108 of FIG. 1, and the indicator candidates can be similar to indicator candidates 109 of FIG. 1.

At 712, method 700 involves determining, by the machine learning engine and based on the one or more feature vectors, one or more indicators from the plurality of indicator candidates. The determination can be similar to operations 224 and 226 of FIG. 2, and the determined one or more indicators can be similar to indicator 106 of FIG. 1.

At 714, method 700 involves tagging, by the data processing system, the event data with the one or more indicators. The tagging can be similar to operation 328 of FIG. 3, and the tagged event data can be similar to tagged data 110 of FIG. 1.

At 716, method 700 involves storing the tagged event data in the hardware storage device.

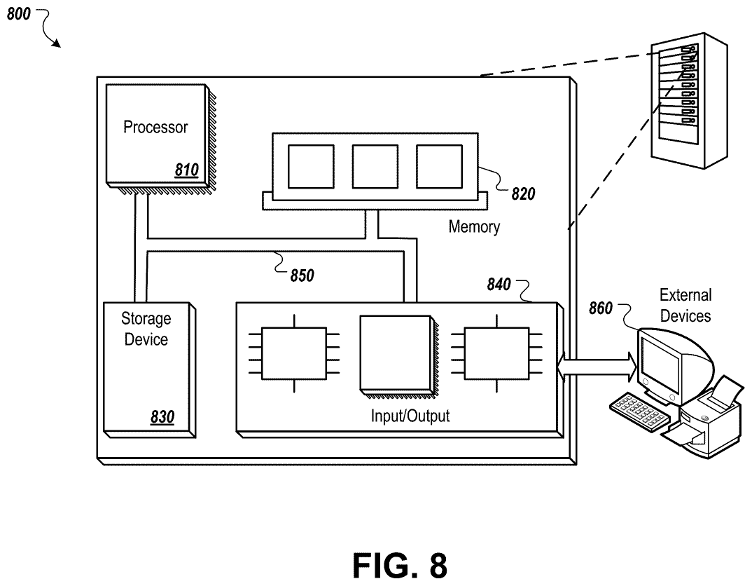

FIG. 8 is a block diagram of an example computer system 800 in accordance with implementations of the present disclosure. The system 800 includes a processor 810, a memory 820, a storage device 830, and one or more input/output interface devices 840. Each of the components 810, 820, 830, and 840 can be interconnected, for example, using a system bus 850.

The processor 810 is capable of processing instructions for execution within the system 800. The term “execution” as used here refers to a technique in which program code causes a processor to carry out one or more processor instructions. In some implementations, the processor 810 is a single-threaded processor. In some implementations, the processor 810 is a multi-threaded processor. The processor 810 is capable of processing instructions stored in the memory 820 or on the storage device 830. The processor 810 may execute operations such as those described with reference to FIGS. 1-7 described herein.

The memory 820 stores information within the system 800. In some implementations, the memory 820 is a computer-readable medium. In some implementations, the memory 820 is a volatile memory unit. In some implementations, the memory 820 is a non-volatile memory unit.

The storage device 830 is capable of providing mass storage for the system 800. In some implementations, the storage device 830 is a non-transitory computer-readable medium. In various different implementations, the storage device 830 can include, for example, a hard disk device, an optical disk device, a solid-state drive, a flash drive, magnetic tape, or some other large capacity storage device. In some implementations, the storage device 830 may be a cloud storage device, e.g., a logical storage device including one or more physical storage devices distributed on a network and accessed using a network. In some examples, the storage device may store long-term data. The input/output interface devices 840 provide input/output operations for the system 800. In some implementations, the input/output interface devices 840 can include one or more of a network interface devices, e.g., an Ethernet interface, a serial communication device, e.g., an RS-232 interface, and/or a wireless interface device, e.g., an 802.11 interface, a 3G wireless modem, a 4G wireless modem, a 5G wireless modem, etc. A network interface device allows the system 800 to communicate, for example, transmit and receive data. In some implementations, the input/output device can include driver devices configured to receive input data and send output data to other input/output devices, e.g., keyboard, printer and display devices 860. In some implementations, mobile computing devices, mobile communication devices, and other devices can be used.

A server can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

In some examples, the system 800 is contained within a single integrated circuit package. A system 800 of this kind, in which both a processor 810 and one or more other components are contained within a single integrated circuit package and/or fabricated as a single integrated circuit, is sometimes called a microcontroller. In some implementations, the integrated circuit package includes pins that correspond to input/output ports, e.g., that can be used to communicate signals to and from one or more of the input/output interface devices 840.

Although an example processing system has been described in FIG. 8, implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. In an example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “computing device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as standalone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a GNSS sensor or receiver, or a portable storage device such as a universal serial bus (USB) flash drive.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tapes, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

While this specification includes many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

What is claimed is:

1. A computer-implemented method, comprising:
receiving, by a data processing system, event data representing a medical safety event;
processing the event data, including:
parsing, by a parser of the data processing system, the event data to identify a structure of the event data; and
identifying one or more fields from the structure of the event data;
inputting, to a machine learning engine, contents of the one or more fields;
generating, by the machine learning engine and from contents of the one or more fields, one or more feature vectors;
accessing, from a hardware storage device, a plurality of indicator candidates;
determining, by the machine learning engine and based on the one or more feature vectors, one or more indicators from the plurality of indicator candidates;
tagging, by the data processing system, the event data with the one or more indicators; and
storing the tagged event data in the hardware storage device.

2. The computer-implemented method of claim 1,
wherein the one or more feature vectors comprise one or more features and one or more corresponding scores.

3. The computer-implemented method of claim 2,
wherein the contents of the identified one or more fields comprise a plurality of words that describe the medical safety event,
wherein the one or more features are determined from the plurality of words, and
wherein the one or more corresponding scores comprise one or more term frequency-inverse document frequency (TF-IDF) scores corresponding to the one or more features.

4. The computer-implemented method of claim 2, wherein determining the one or more indicators from the plurality of indicator candidates comprises:
determining a probability value corresponding to each indicator candidate based on the one or more features and the one or more corresponding scores;
comparing the probability value corresponding to each indicator candidate with a probability threshold value; and
selecting the one or more indicators whose corresponding probability values are greater than the probability threshold value.

5. The computer-implemented method of claim 1, further comprising:
training the machine learning engine with a set of sample event data, wherein the sample event data are tagged with one or more sample indicators.

6. The computer-implemented method of claim 5, wherein training the machine learning engine with the set of sample event data comprises:
obtaining one or more sample feature vectors from the sample event data;
obtaining an indicator vector from the sample event data, wherein the indicator vector comprises a plurality of fields indicating a presence or absence of the plurality of indicator candidates; and
inputting the one or more sample feature vectors and the one or more indicator vectors to a logistic regression classifier to obtain a prediction model.

7. The computer-implemented method of claim 6, wherein training the machine learning engine with the set of sample event data further comprises:
obtaining one or more prediction metrics from a set of test event data; and
determining a probability threshold value for the prediction model.

8. The computer-implemented method of claim 7, wherein the one or more prediction metrics comprise: a precision threshold value and a recall threshold value.

9. The computer-implemented method of claim 1, wherein determining the one or more indicators from the plurality of indicator candidates comprises:
determining a parent indicator from the plurality of indicator candidates; and
determining a child indicator from the plurality of indicator candidates based on the parent indicator,
wherein the one or more indicators are determined as at least one of the parent indicator or the child indicator.

10. The computer-implemented method of claim 1, further comprising:
receiving a query that comprises a given event indicator;
searching the tagged event data in the hardware storage device; and
displaying a search result of event data that are tagged with the given event indicator.

11. The computer-implemented method of claim 1, further comprising:
creating, by the machine learning engine, a new indicator candidate; and
storing the new indicator candidate by the hardware storage device.

12. The computer-implemented method of claim 1, further comprising:
performing k-means clustering analysis according to the one or more features.

13. A non-transitory computer-readable medium storing program instructions that cause a data processing system to perform operations comprising:
receiving event data representing a medical safety event;
processing the event data, including:
parsing the event data to identify a structure of the event data; and
identifying one or more fields from the structure of the event data;
inputting, to a machine learning engine, contents of the one or more fields;
determining, by the machine learning engine and from contents of the one or more fields, one or more feature vectors;
accessing, from a hardware storage device, a plurality of indicator candidates;
determining, by the machine learning engine and based on the one or more feature vectors, one or more indicators from the plurality of indicator candidates;
tagging the event data with the one or more indicators; and
storing the tagged event data in the hardware storage device.

14. The non-transitory computer-readable medium of claim 13,
wherein the one or more feature vectors comprise one or more features and one or more corresponding scores.

15. The non-transitory computer-readable medium of claim 14,
wherein the contents of the identified one or more fields comprise a plurality of words that describe the medical safety event,
wherein the one or more features are determined from the plurality of words, and
wherein the one or more corresponding scores comprise one or more term frequency-inverse document frequency (TF-IDF) scores corresponding to the one or more features.

16. The non-transitory computer-readable medium of claim 14, wherein determining the one or more indicators from the plurality of indicator candidates comprises:
determining a probability value corresponding to each indicator candidate based on the one or more features and the one or more corresponding scores;
comparing the probability value corresponding to each indicator candidate with a probability threshold value; and
selecting the one or more indicators whose corresponding probability values are greater than the probability threshold value.

17. The non-transitory computer-readable medium of claim 13, the operations further comprising:
training the machine learning engine with a set of sample event data, wherein the sample event data are tagged with one or more sample indicators.

18. The non-transitory computer-readable medium of claim 17, wherein training the machine learning engine with the set of sample event data comprises:
obtaining one or more sample feature vectors from the sample event data;
obtaining an indicator vector from the sample event data, wherein the indicator vector comprises a plurality of fields indicating a presence or absence of the plurality of indicator candidates; and
inputting the one or more sample feature vectors and the one or more indicator vectors to a logistic regression classifier to obtain a prediction model.

19. The non-transitory computer-readable medium of claim 18, wherein training the machine learning engine with the set of sample event data further comprises:
obtaining one or more prediction metrics from a set of test event data; and
determining a probability threshold value for the prediction model.

20. The non-transitory computer-readable medium of claim 19, wherein the one or more prediction metrics comprise: a precision threshold value and a recall threshold value.
